(19) United States
(12) Patent Application Publication
(10) Pub. No.: US 2019/0034961 A1
(43) Pub. Date: Jan. 31, 2019

(54) METHOD FOR TARGETING ELECTRONIC ADVERTISING BY DATA ENCODING AND PREDICTION FOR SEQUENTIAL DATA MACHINE LEARNING MODELS

(71) Applicant: ACCELERIZE INC., Newport Beach, CA (US)

(72) Inventor: Karl D. Gierach, Irvine, CA (US)

(73) Assignee: ACCELERIZE INC, Newport Beach, CA (US)

(21) Appl. No.: 16/037,497

(22) Filed: Jul. 17, 2018

Related U.S. Application Data
(60) Provisional application No. 62/537,333, filed on Jul. 26, 2017.

(51) Int. Cl. G06Q 30/02; G06N 5/02

(52) U.S. Cl. CPC G06Q 30/0244; G06N 5/02

(57) ABSTRACT

A method of encoding sequential data that allows encoding a subsequence of full sequences as a composite data symbol, wherein a subsequence is comprised of a maximum of one original data element, and a maximum of K original data elements. These composite data symbols, arranged sequentially, can then be used to train a machine learning model, and thus reduce complexity when a strict ordering within the context of the original data subsequences is not required, while still modeling synergies between the sequential data elements. Further, the method determines a set of related data elements to a composite symbol at the next time step, given the original subsequence. Given this set of related data symbols, prediction can be performed with the machine learning model, by picking the maximal likelihood path using the disclosed search tree algorithm intended for state space models, which probabilistically model a hidden state given a prior hidden state, and probability of observable data symbols, given a hidden state. In addition, a method of training such a machine learning model based on a real-world embodiment of advertising/marketing data is presented. After a machine learning model of this nature has been trained, it then can be used for prediction using the search tree algorithm.

### CROSS REFERENCE TO RELATED APPLICATION

This application claims the benefit of U.S. Provisional Patent Application, Ser. No. 62/537,333, filed on 26 Jul. 2017. The co-pending provisional application is hereby incorporated by reference herein in its entirety and is made a part hereof, including but not limited to those portions which specifically appear hereinafter.

### BACKGROUND OF THE INVENTION

### Field of the Invention

The present invention is directed to the field of machine learning, with a subfield being graphical state-based models. More specifically it includes a mathematical model capable of predicting probabilities of observable events, given a sequence of ordered observable data, or alternatively, predicting the probability that a system enters a specified state within an unobservable state model, given a set of ordered observable data events. In addition, the model can predict the most likely sequence of observables one should observe to cause the system to enter a desired state (or one of a set of states) within the state model.

### Description of the Related Art

Machine learning is a subfield of computer science where the goal is to build a mathematical and/or statistical model based on data that has been observed. After the model has been built, the model can be used in various ways to provide prediction. If the model characterizes state, in terms of a probability given some observable data, then the model can predict current state, or the most likely state sequence, given a fixed sequence of data. That said, if the state is held fixed, the model can be used to predict which sequence of data elements shall be most likely to transfer the model into a desired state.

To reduce complexity and make building a model tractable, without an inordinate amount of data, it is often assumed that the current state of the system is conditionally dependent only on the prior state of the model. This type of model is referred to as a first order Markov Model. The model complexity can be extended to consider the current state of the system conditioned on the prior two states of the system. As model complexity increases, the amount of data required to train the model also clearly increases, since there are exponentially more combinations of state sequences that must be considered. In addition, as the model's complexity increases, the computational complexity to train the model also increases.

When a computer scientist or statistician builds a Markov model to estimate state, and couples that model with observables, it is often assumed the state of the model is not directly observable. When the probability of an observable data point, coupled with the probability of state is modeled, this type of model is referred to as a Hidden Markov Model (HMM). The foundational concepts of the HMM extends back into the 1960s with work done by R. Stratonovich and L. Baum. Since that time, several variations of the HMM have been proposed by researchers in the fields of computer science and statistics. During this time, the models were applied to many fields including speech recognition, analysis of DNA sequences, stock market prediction, and more recently, the fields of advertising and marketing. This section next provides a brief overview of the central use-cases of the HMM. However, it must be noted that the basic HMM is parameterized by 3 separate structures denoted as it, A, and B, which denote the initial probability of the start state, the probability of a state transition, and the probability of observing a symbol upon arrival at a new state. As such the it structure is a stochastic vector, and A and B are both stochastic matrices, wherein the rows of each matrix sums to 1.0, forming a discrete probability distribution.

When dealing with HMM, there are three main problems that users of the models are concerned with, as detailed by Rabiner, Lawrence R., “A Tutorial on Hidden Markov Models and Selected Applications in Speech Recognition,” Proceedings of the IEEE, Vol. 77, No. 2 (February 1989):
1. Given an observation sequence, compute the probability of an observation sequence, given the model.
2. Given an observation sequence, compute the optimal hidden state sequence or traversal which best explains the observations.
3. How to train the model's parameters, given an observation sequence in order to maximize the probability of the observation sequence. This is also referred to as Learning, within the machine learning literature.

For reference, the first problem can be answered by and algorithm commonly referred to in the literature as the “Forward Algorithm”. The second problem is commonly solved by the “Vitterbi Algorithm”, which leverages the results of a dynamic programming solution known as the “Forward-Backward Algorithm”. The third problem can be solved by a mechanism known as Expectation-Maximization using the results of the Forward-Backward algorithm, wherein model parameters are updated iteratively until the model updates have converged. Rather than repeating the details of these techniques, please consult Rabiner (above) for a concise description of the solutions to these problems.

Other common terminology used by researchers includes the following:
1. Filtering: compute the belief state at time t, given the sequence of observations from 1 to t.
2. Smoothing: compute the believe state at a time t, given more evidence observables from time 1 to T, where t<=T.
3. Prediction: predicting the future given the past observables from time 1 through t. There are two contexts for this, first, prediction of the most likely state at some time horizon h in the future, and second, the most likely observation given a specified state transition at time t+h.

With respect to learning, it is also possible to train an HMM using fully observed data, which includes both the observations and the hidden state transitions (or alternately, estimates of hidden state transitions). The procedure is well documented by Murphy, “Machine Learning a Probabilistic Perspective”, MIT Press (2012). The A matrix and π can both be estimated by simple formulae, which only take state transitions into account. The B matrix is estimated based on the number of times a symbol is observed, with respect to the system being within a given state.

Other topics of interest developments within the field of HMMs include using Bayesian methods for training the HMM. Sampling is used in these scenarios to provide better parameter estimates, as they will be able to quantify the confidence intervals for the parameters. See Fruhwirth-Schnatter, “Finite Mixture and Markov Switching Models”, Springer (2007), for additional details.

Other issues of interest to the practitioners in this field include the following: methods for identifying states due to label switching, model selection; namely picking the number of hidden states, and the topology allowed for the state transitions.

A relevant extension to the standard HMM is the “Variable Duration HMM”, which models the number of time steps that are expected to pass while the system remains in a particular state. This extension to the basic HMM can be particularly useful when used with observations that occur within a time-series or time-stamp labelled event series, to capture state transitions more accurately from a timeline based perspective. See Djuric, P. et al., “A MCMC Sampling Approach to Estimation of Non-Stationary Hidden Markov Models”, IEEE Transactions on Signal Processing (May 2002), for details on this approach.

Another type of extension to an HMM is termed the Input/Output HMM. In this case the HMM takes and input signal, referred to as the control signal, which affects the state transitions joint probability with the outputs. A derivation exists in Bengio et al., “Input/Output HMMs for sequence processing”. IEEE Trans. Neural Networks 7(5), 1231-1249 (1996).

Auto-Regressive HMMs allow for the observation symbols to be dependent not only on state, but also on the prior observation symbol. An observation model can be based on continuous data (floating point numeric data), or discrete data. The model is estimated with linear regression, and can take into account higher order extensions, thus capturing the last “N” observations. These models are used in Econometrics; see Hamilton, “Analysis of time series subject to changes in regime”, Journal of Econometrics 45, 39-70 (1990), for details.

Other topological variations with HMMs exist. The Factorial HMM allows for the probability of an observable to be based on multiple states, wherein some states may be present simultaneously. The Coupled HMM specifies a topology wherein multiple simultaneous Markov Chains are present, and at the same time state transitions are influenced probabilistically by “neighboring” chains, while each chain produces its own separate observable data stream. See Murphy, P., “Machine Learning a Probabilistic Perspective”, MIT Press (2012), for an overview.

As previously mentioned, HMMs have been applied successfully in many fields. One application of interest by Abishek et al., “Media Exposure through the Funnel: A Model of Multi-Stage Attribution”, The Mack Institute (August 2012), uses the HMM to model the Marketing Funnel. In this case, they model the states of the marketing funnel as the states of the HMM, and frame the state transition matrix as a multiple logistic regression problem, computed using observations as the data. In this case, a set of coefficients or weights is estimated in the training process for each separate state transition.

The general approach of this model is that of a linear model. However, in the case of online advertising and marketing, modeling the path to conversion is often non-linear, and one may consider ordering of events, a partial ordering of events, or a non-ordering of events. This fact provides an opportunity to take a different approach with HMMs, and build a model to capture this nonlinearity. The present invention provides such an approach.

### SUMMARY OF THE INVENTION

A general object of the present invention is to provide a method and system for performing an estimate of an individual's position within a conceptual state space. An exemplary state space is the marketing funnel within the context of an online environment. A key attribute of the present invention is its ability to capture effects of the various attributes of observable variables. In the embodiment of online advertising, these attributes include items such as the publisher, which may have a synergistic effect with a different publisher. Thus, these synergistic effects must be captured by the invention and then used to make reliable predictions. An important realization is that the synergistic effects may be order dependent or order independent. The synergistic effects may also be related by time, thus they may only be present within an approximate time window.

Another object of the present invention is to provide a method and system for predicting which observable data attribute is most likely to be observed next. In the field of online advertising, the observable data attribute is an advertising effect that can be used on a specified user, in order to move him or her up the marketing funnel towards conversion. Advertising effect denotes, but is not limited to, the publishing entity, the publishing channel type, or the advertising message or attributes of the ad. The mathematical models provided by this invention are trained with the chosen attributes.

Another object of the invention is to provide a method and system for performing a collective estimate for predicting observations, based on an aggregation of the model's predictions, when multiple separate event streams are run through the model. In the case of online advertising, this aggregation can suggest a proportion of publishing channels or publishing mediums (as an example), that should be used, moving forward in the advertising campaign. This estimate can then be used to reallocate ad spending across the advertising entities reflected by the model in this application.

In some embodiments within the field of online advertising, the data is procured by a centralized advertisement tracking authority which tracks presentation of ads to users on the internet, clicks on ads by users on the internet, and conversions; which are events of interest to the Advertiser, such as a product purchase or providing personal contact information on a digital form. In other embodiments, the data is obtained by collection of usage from advertising networks, and then stitched together sequentially prior to analysis. In some embodiments only clicks and conversions are available for analysis. In other embodiments, other attributes or event types may be available for analysis.

According to this method, the consumer or target operates either a consumer electronic device equipped with a web browser or otherwise capable of viewing ads in various formats, including but not limited to display ads, video ads, and text-only ads. He or she may view such ads via different advertising channels or mediums, including but not limited to search, organic search, social media, mobile applications, and email. Ads may be shown by or attributed to affiliate networks, which may use a combination of channels or mediums.

The invention includes a method of directing electronic advertising to targeted consumers. The method includes: tracking digital advertisement interactions for a consumer on one or more electronic devices; collecting advertising data for the consumer from the tracking; modeling the advertising data to obtain a predicted advertisement channel for display on the one or more electronic devices; and displaying a further digital advertisement to the consumer on the one or more electronic devices or a second consumer, via the predicted advertisement channel. All steps are preferably automatically performed by a suitable computer system in tracking communication over a network with the consumer device(s). In embodiments of this invention, tracking digital advertisements interactions comprises tracking and collecting raw data on presentations of advertisements to the consumer(s), clicks on the advertisements by the consumer(s), and sales conversions resulting from the clicks on the advertisements. The raw data can be organized in a timeline, and the timeline converted into an event stream of K-tuples. The method can further includes training a Hidden Markov Model with the event stream of K-tuples that resulted in sales conversions.

The invention further includes an automated method of directing electronic advertising to targeted consumers, which includes: tracking digital advertisement interactions for a plurality of consumers via electronic devices; collecting advertising data for the consumers from the tracking; automatically grouping the advertising data by a consumer identification; automatically creating event streams from the advertising data in each group; automatically modeling the advertising data to obtain a predicted advertisement channel for display to a further consumer; and displaying a further digital advertisement to the further consumer on an electronic device according via the predicted advertisement channel. The method preferably also includes identifying converted event streams within each group, and training a Hidden Markov Model with the converted event streams.

The predicted advertising channel can be applied to non-converted event streams, for targeting the consumer(s) with more effective advertising to convert sales. In embodiments of this invention, advertising channel patterns are determined for the converted event streams, wherein the predicted advertisement channel is selected from one or more of the advertising channel patterns for the converted event streams. The predicted advertising channel is applied to non-converted event streams to stimulate sales conversion.

In embodiments of this invention, the consumer tracking includes automatically monitoring and analyzing a predetermined advertising variant among the raw data for the modeling. The predetermined advertising variant can be, for example, inter-click durations of a clickstream of the event streams, wherein a faster inter-click duration results in a state transition forwards while a slower than usual inter-click duration results in a state transition backwards. The method then includes forcing a transition to a final converted state at a last click in each of the event streams, and predicting a most likely entity of interest for the each of the event streams. Furthermore, when this method is coupled with a mechanism that models inter-click durations as probability distributions, maximum likelihood of the probability distribution can be employed as guide indicating precisely not only what medium to show an advertisement, but when to show that advertisement.

Other objects and advantages will be apparent to those skilled in the art from the following detailed description taken in conjunction with the appended claims and drawings.

### BRIEF DESCRIPTION OF THE DRAWINGS

FIG. 1 is a flow diagram generally illustrating embodiments of this invention.

FIG. 2 is a flowchart describing the overall algorithm for training the HMM with data from logged advertising events, and then using the HMM for prediction, according to embodiments of this invention.

FIG. 3 is a flowchart describing the mechanism for encoding the K-Tuple observation using a lookup table that is initialized prior to the HMM training, according to embodiments of this invention.

FIG. 4 is a flowchart and algorithm pseudocode describing the mechanism for performing prediction using a search tree algorithm, according to embodiments of this invention.

FIG. 5 is a block diagram showing entities of the entire apparatus and method with respect to the noted embodiment of online advertising, according to embodiments of this invention.

### DETAILED DESCRIPTION OF THE INVENTION

The invention provides a method for performing an estimate of an individual's position within a conceptual state space, and an apparatus or system for implementing the method. The method is beneficial for various uses, but is described herein with reference to electronic or online advertising. The method of this invention provides the ability to capture effects of the various attributes of observable variables. In embodiments directed to online advertising, exemplary attributes include items such as the publisher, which may have a synergistic effect with a different publisher. These synergistic effects are captured and then used to make reliable predictions. An important realization is that the synergistic effects may be order dependent or order independent. The synergistic effects may also be related by time, thus they may only be present within an approximate time window.

The method of this invention can be implemented via a server computer, or a cluster of computers, to process data collected via an open digital network of heterogeneous consumer or client devices, such as via the Internet. The method and system of this invention desirably function via a machine learning algorithm which leverages and significantly extends a technology commonly referred to in the computer science literature as the Hidden Markov Model, although other names exist in the literature essentially referring to these same types of models, such as State-Space models, Dynamic Bayesian Networks, or Graphical Models. As mentioned above, the invention will be described with respect to application within the online advertising domain, however embodiments of this invention include or can be extended to other domains or environments dealing with ordered event data. At the computing location, a computing device is present which executes software code instructions comprising the process and articles of manufacture of the invention. A code may be loaded into the memory of the computing device from a machine-readable medium, such as a CD, a DVD, a flash memory, a floppy or a hard drive, a network-based storage service, or a similar memory or storage device. The data which the invention processes similarly may be loaded into the memory of the computing device.

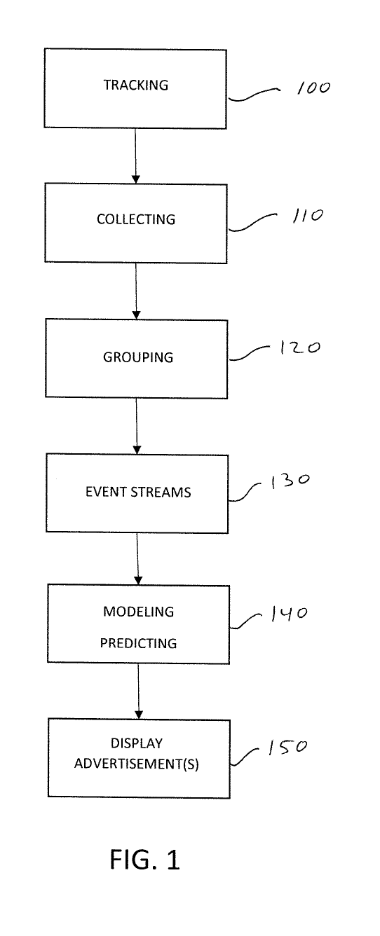

FIG. 1 generally illustrates broader aspects of this invention in a flow diagram of directing electronic advertising to targeted consumers. In initial step 100, the method includes tracking digital advertisement interactions for a plurality of consumers on their electronic devices. The advertising data is collected and organized and/or analyzed for further processing in step 110. The advertising data is automatically grouped by a consumer identification in step 120. Embodiments of this invention create event streams 130 from the advertising data in each group from step 120. Additionally, event streams that resulted in sales, herein referred to as converted event streams, can be identified for use and further analysis and prediction use. Focusing on converted event streams is beneficial in embodiments of this invention, as a goal of the method is to provide targeted advertising that is effective in converting sales.

In embodiments of this invention, the consumer tracking includes automatically monitoring and analyzing a predetermined advertising variant among the raw data for the modeling. As discussed further below, one generally preferred predetermined advertising variant can be, for example, inter-click durations of a clickstream of the event streams, wherein a faster inter-click duration results in a state transition forwards while a slower than usual inter-click duration results in a state transition backwards. Other variants include, without limitation, advertising symbols and/or other clickstream statistics such as overall clickstream duration, number of touch points, time-stamp derived features, or combinations thereof.

In step 140, the method includes automatically modeling the advertising data to obtain a predicted advertisement channel for display to a further consumer. As described further below, the modeling and predicting can include training a Hidden Markov Model with the converted event streams. The resulting model can be used to determine advertising channel patterns for the converted event streams of the data, and the predicted advertisement channel is selected from one or more of the advertising channel patterns for the converted event streams. The information from the predicted advertising channel is then applied to current or future non-converted event streams to stimulate sales conversion, such as by displaying 150 a further digital advertisement to a further consumer on an electronic devices according via the predicted advertisement channel.

The advertising effectiveness and synergies between advertising channels, such as website A and website B is unknown, and may be linear, non-linear, order dependent, or order-independent, or some combination of these. The method provided by the present invention extends the standard Hidden Markov Model in a novel manner, which allows the observations (e.g., advertisements presented to a particular user) to be combined into groups or tuples of observations. In embodiments of this invention, these observations tuples are K-Tuples wherein each K-Tuple represents K consecutively occurring online advertisements or advertising related events. Three separate mechanisms are described, which are: 1) fully ordered, 2) non-ordered, and 3) semi-ordered. As previously stated, one benefit of the invention is to build an accurate model which can predict the next best advertising publisher (or other attribute) to be used on a particular user. It is unknown a priori whether the synergies between advertising channels will be ordered, non-ordered, or semi-ordered. Therefore, the algorithm can be executed in at least three separate modes, and then back-tested for accuracy for the particular application. However use of the simpler non-ordered model requires significantly less data to build an accurate model, thus it is most suitable in the general case.

Besides presenting a mechanism for feature encoding, embodiments of the present invention also include a mechanism for evaluating the Hidden Markov Model (HMM) for prediction in a novel way, using the K-Tuple concept. Furthermore, in conjunction with the K-Tuple encoding, the invention includes a novel algorithm for evaluating the HMM, which has empirically outperformed the standard methods documented in the literature.

The method of this invention also may be used with Variable Duration HMMs whenever the input data stream is associated with timestamps. In the case of the primary embodiment presented here, applied to advertising data, these events in the data stream are time-stamped, and thus this use case warrants mentioning.

Reference will now be made in detail to several embodiments of the invention that are illustrated in the accompanying drawings. The drawings are in simplified form, not to scale, and omit apparatus elements and method steps that can be added to the described systems and methods, while including certain optional elements and steps.

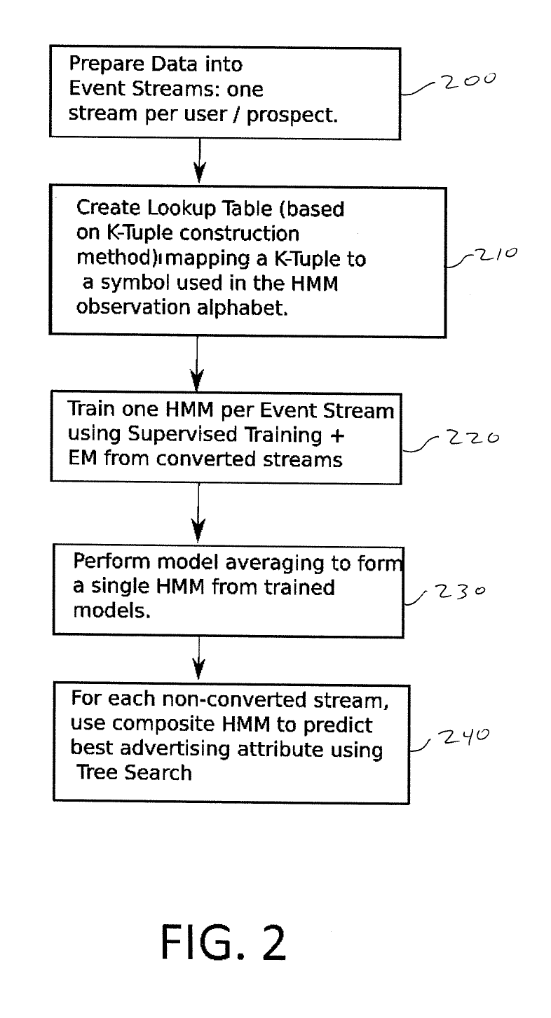

FIG. 2 is a flowchart according to one embodiment of this invention, describing the overall algorithm for training an HMM with data from logged advertising events, constructing an overall predictive HMM for the particular advertising campaign, and then using that model to perform prediction to indicate which advertising channels should be used next as the basis for advertising to unconverted prospective customers in order to achieve conversion. Referring to FIG. 2, the machine learning model is trained with data, and then later used to predict which next data will most likely lead to conversion. In a preferred embodiment, the next data is something that the advertiser can explicitly control, at possibly multiple levels, thus providing the utility of the invention. In Box 200 the raw advertising data is prepared prior to being used on the model training. Each data point collected is tagged with a user-specific identifier, and a time stamp. Thus, an ordinary software developer of reasonable skill may author code, or leverage an existing database technology system to group the data by user ID, and then within those groups, order the data by the timestamp, ascending from earliest to most recent point in time. This step is a preparation executed on the data. In some embodiments, this step may not be explicitly required in the case where the data is already in this format; namely grouped by User/Prospect and ordered by time.

In step 210, a lookup table for the K-Tuples is constructed. It should be noted that the unordered K-Tuple technology is an improvement over a strictly ordered list in that there are significantly less symbols overall, thus resulting in a more even coverage of the model during training, due to less sparsity given a moderate training data set size. However, if the collected data is very large, it is conceivable that a strictly ordered tuple model will have enough coverage, and may provide better prediction accuracy. However, in the cases where order may matter, and the data do not have enough variance to properly cover the model, a semi-ordered K-Tuple may be implemented. For the case of the un-ordered tuple, the table is initialized as follows: starting with N count advertising symbols, an unsigned integer of size 64 bits may adequately cover up to 64 different symbols, wherein one bit in the integer will be set per advertising symbol set in the list. In some embodiments, an advertising symbol may in-fact be a channel type of a publishing website used to display the advertisement to the end user. In other embodiments, an advertising symbol may refer to an identifier of the publishing website. Yet in other embodiments, the advertising symbol may refer to a well-defined discrete attribute of the advertisement's creative (image). If the symbols are arranged in an ordered list, the list can be indexed from number 0 through N-1. These indexes can directly be translated to the indexes of the bits present in a K-Tuple representation. For each possible K-Tuple representation, a lookup table located in the computer's memory can deterministically map the numeric value of the K-Tuple to a discrete symbol ranging from 0 to M-1, where there are M total combinations of K tuples. The exact method of constructing the table will be variable and several methods will be obvious to those skilled in art of software development. However, use of the table in the context of the invention is important. The important attributes of the K-Tuple are that: 1) in the integer representing the K-Tuple, the most significant bit that can be set is bit index N-1; 2) the least significant bit that can be set is bit 0; 3) the maximum number of bits set in the K-Tuple is K; and 4) the minimum number of bits that can be set is 1.

It is of interest to note that if a K-Tuple has only K-1 bits set, one can choose to set one more of the allowed bits, thus forming a new K-Tuple. The set of new K-Tuples can be defined as the set of “Related K-Tuples” with respect to the original K-Tuple with only up to K-1 Bits set. Following this paradigm, if one takes a first K-tuple with K bits set, and then clears the bit corresponding to the eldest advertising entity's event observed in the tuple, the K-tuple is transformed to a second K-1 tuple, and can then find the set of related K-tuples to this transformed second K-tuple. Thus, it is possible to train the model with K-Tuples as observations, and in the prediction phase, restrict the set of predicted advertising entities to those entities which formed the set of related K-tuples. It is also worth noting that, given a first K-Tuple related to a second K-tuple in the manner described, it is a simple bitwise XOR operation between K-tuple integer representations which allow the programmer to detect the differing bit, which in turn corresponds to the newly added advertising entity in the second K-Tuple.

Step 220 includes training the HMM with an event stream comprised of K-Tuples. In embodiments of this invention, advertising symbols and/or clickstream statistics are used to identify the at least one event stream for training. Exemplary clickstream statistics include, without limitation, inter-click duration, overall clickstream duration, number of touch points, time-stamp derived features, or combinations thereof.

According to embodiments of the invention, the method of training the HMM is to first implement supervised training using the following heuristic. If the HMM is trained on converted data, the event stream ends with a conversion, thus it is possible to estimate the hidden states path based on inter-click frequency. More frequent clicks on ads typically implies an increased awareness or interest in the product being advertised. The average inter-click duration of all clickstreams in the training set can be used as a baseline B, along with some empirically determined multiple P of the standard deviation S (square root of variance), a heuristic determined as follows: 1) move from the initial state to the second state on the first click (event); 2) move forward a state when the interclick duration is less than (B−P*S); 3) move backwards a state when the interclick duration is greater than (B+P*S); 4) remain in the same state otherwise; and 5) force a transition to the final state (representing the converted state) at the last click in the event stream. In some embodiments, B is equal to 1.0, while in other embodiments B is less than or greater than 1.0.

In embodiments of this invention, a multimodal distribution of one or more advertising co-variates implying state transition probability is determined through statistical analysis in accordance with state-of-the-art techniques. A transition forward a state is assumed based on maximum likelihood inferred from the probability mass function of the multimodal distribution component representing a forward transition, whereas a transition backwards is assumed based on the maximum likelihood inferred from the probability mass function of the multimodal distribution representing a backwards transition; given a probability distribution, analytical or empirical, is used for each distribution. If the absolute value of the difference between the probability mass functions is less than some tolerance level T, then the transition represents a self-transition.

In some embodiments of this invention, a multimodal distribution of the inter-click duration is determined through statistical analysis in accordance with state of the art techniques. A transition forward a state is assumed based on maximum likelihood inferred from the greater mean and variance of the multimodal distribution, whereas a transition backwards is assumed based on the maximum likelihood inferred from the lesser mean and standard deviation of the multimodal distribution, assuming a Gaussian distribution's parameters for each distribution, If there is not a strong enough certainty as to which distribution the touch point belongs to, then the method remains in the same state.

Bayesian analysis can also be performed, and maximum likelihood can be determined via sampling, using Markov-Chain Monte-Carlo (MCMC) methods. In this manner the transition probability distributions of the individual clickstreams are inferred, while using the aggregate clickstreams as the prior distribution for the Bayesian analysis.

In other embodiments, an expectation-maximization can be used. For example, the state transition distributions of the HMM is determined across all clickstreams using the Expectation-Maximization (EM) algorithm, using the inter-click duration and/or other advertising co-variates as the variable(s) of analysis, while incorporating the same transition restrictions as noted above. As an optional extension to the EM method, one may force a final state transition to the converted state, thus implementing a largely unsupervised training mechanism while coupling a supervised training mechanism. Then, once the model is trained, regardless of the training method used, the model can be used for prediction.

Other ways to model the state transitions of the converted data incorporate covariates. For example, supervised training can be accomplished via the inter-click duration heuristic mechanism, and then use those results to train logistic functions representing the probability distributions of each state transition, then use those ‘trained’ logistic functions as a mechanism for prediction on the non-converted streams.

In step 230, one first recalls that one HMM is trained per event stream. After the supervised training, the EM algorithm is applied to smooth the parameters of each event stream's model. After all training, the model parameters are then averaged into a new composite HMM which represents the likelihoods for the state transitions and observation models observed in the data. In some embodiments, it can produce better results to cluster the events streams into groups, prior to training the composite HMM. If L clusters are used, then there will result in L composite HMMs. Finally, in step 240, the composite HMM may now be used for prediction.

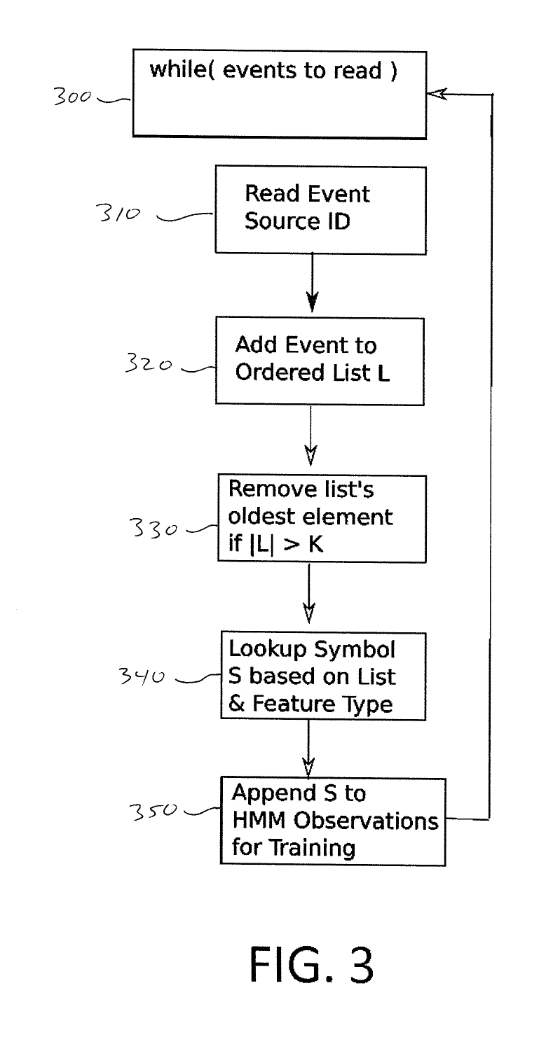

FIG. 3 is a flowchart describing the mechanism for encoding the K-Tuple observation using a lookup table that is initialized prior to the HMM training, according to embodiments of this invention. Referring to FIG. 3, one can examine the method used to convert the event stream of data events into an event stream of K-tuples suitable for training the Hidden Markov Model. Each event is desirably processed individually from the stream in order of time, starting at the oldest time stamp. A list “L” is established, which holds identifiers of the advertising entities of concern. At step 300, an event is read from the input data, if the stream is not empty, as described. If the stream is empty, then terminate the tuple formation. At step 310, the ID of the entity is mapped to an integer from range 0 to N-1, where there are N discrete advertising entities under consideration. At step 320, the ID is appended to the list L. The first element of the list L can be removed if the size of the list is greater than K. The lookup table is then used 340 as previously described to determine Symbol S corresponding to the K-Tuple represented by the items in the list. Symbol S is then emitted to the output stream of data, which will then be used as the observations for training the model in step 350. In some embodiments, the method of determining the K-tuple may use a fully ordered paradigm, a non-ordered paradigm, or a partially ordered paradigm.

The following equations illustrate in mathematical notation the number of symbols in the alphabet for various K-Tuple paradigms, namely fully ordered, non-ordered, and semi-ordered. This number must be known as this describes the alphabet size for the observable elements in the Hidden Markov Model. Equation 1 denotes the number of K-Tuples for a non-ordered paradigm, which is simply N raised to the power K.

|ObservationsFullOrdered|=N^{K} (1)

where N represents the number of entities such as publishing channel types involved in the advertising campaign under consideration, and K represents the maximum number of contiguously occurring observations in a data stream mapped into each tuple. Equation 2 describes the number of K-Tuples used for an unordered observation paradigm.

$$\vert ObservationsKTuple \vert = {\sum }_{k = 1}^{K} \frac{N !}{k ! ( N - k ) !} \qquad ( 2 )$$

Finally, Equation 3 describes the number of K-tuples for a partially ordered K-Tuple where one only cares about the order of the outer 2 events; i.e., the most recent and eldest occurring event being represented by the tuple, while not considering the inner elements' ordering.

$$\vert ObservationsSomeOrdered \vert = ( {N}^{2} ) {\sum }_{k = 1}^{K - 2} \frac{N !}{k ! ( N - k ) !} \qquad ( 3 )$$

As will be appreciate by those skilled in the art from the disclosure herein, other similar paradigms may be used to determine the K-Tuple count and corresponding lookup table.

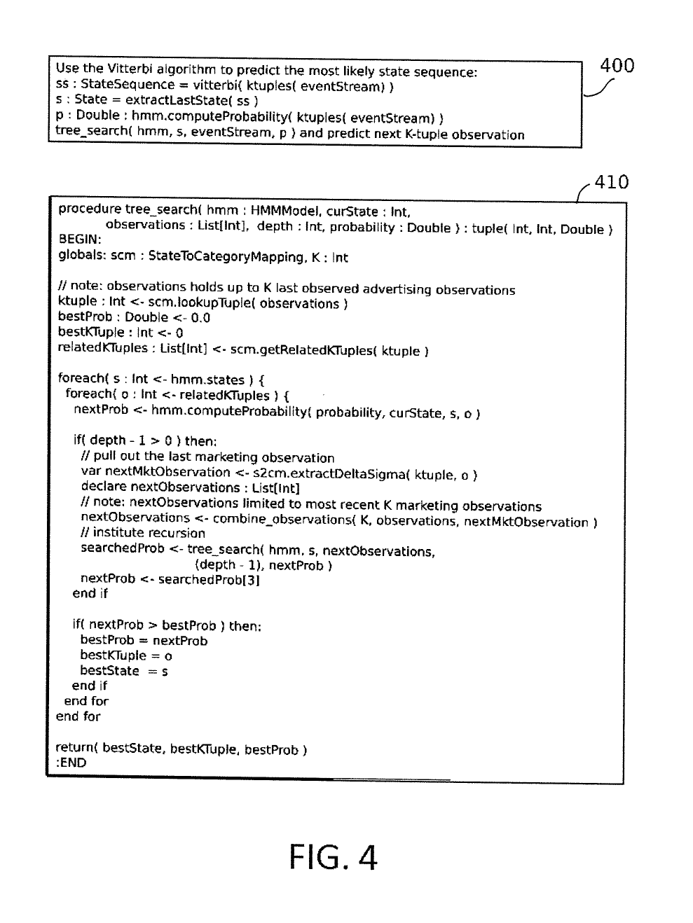

In preferred embodiments of this invention, a tree-search algorithm is used for prediction. FIG. 4 is a flowchart and algorithm pseudocode describing the mechanism for performing prediction using a search tree algorithm according to embodiments of this invention, and then extracting the advertising attribute (needed to induce conversion) from the predicted alphabet symbol predicted by the HMM. In embodiments of this invention, the search tree algorithm treats the HMM as a graph, which can be descended to some fixed depth, to thus determine the most likely path moving into the future, given the past. The search tree algorithm is desirably provided with the most likely final hidden state given the observations. It also is desirably provided with a list of final K observations of advertising or marketing data coming directly from the event stream (not K-tuple observations). The search tree algorithm is also desirably provided with the HMM model.

Box 400 of FIG, 4 describes the overall steps required to make use of the search tree algorithm, by gathering the necessary inputs to the algorithm. It is assumed one has already determined the fixed value K, and has populated the lookup table with a mapping, which maps the set of marketing/advertising attributes to K-Tuples. In FIG. 4, the first computational step uses the Vitterbi algorithm to determine the most likely state sequence given the model. In this embodiment, all one cares about is the last state in the most likely state sequence. Assuming this state sequence is stored in a time-ordered list, extracting this state is trivial; one simply retrieves the last element in the list. The probability of the observations is computed, given the model. The search tree algorithm is now invoked, however the search tree algorithm must be provided with a depth parameter, which is an integer >1. That said, in certain embodiments the top-level depth parameter will be assigned a value of 3 when the search tree algorithm is first invoked for a given user's event stream. However, the value can be set after experiments are run to determine the optimal tradeoff between more computational overhead (greater depth), and the greater predictive accuracy achieved by this depth. Obviously depth D should not be increased when significant improvement in accuracy stops with respect to the depth D-1.

Box 410 in FIG. 4 provides details of an exemplary search tree algorithm. The pseudocode procedure ‘tree_search’ begins by looking up the K-Tuple value corresponding to the last K marketing observations, and storing this in computer memory denoted by variable name ktuple'. The list of related K-tuples to this particular K-Tuple is retrieved, the procedure of which is described earlier herein. Next, an outer loop over possible states is entered, and an inner loop over related K-tuples. Within the inner loop, the probability of state transition is first computed from the current state to the proposed state, given an emission of the current related K-tuple under consideration, and this is stored in computer memory denoted by variable name ‘nextProb’. Note that ‘nextProb’ is scaled by the input probability value originally provided to the ‘tree_search’ function. The search tree algorithm is recursed again, if the depth is >1, but when recursing one passes in depth −1 as the depth argument, the ‘nextProb’ as the probability argument, and a modified list of marketing observables corresponding to the current related K-tuple under consideration while preserving the order of the marketing events originally provided to the algorithm. If recursing, the output probability is reassigned as ‘nextProb’. Irrespective of recursion, save the best output symbol and probability and best state prior to the next loop iteration. These three values are conceptually treated as a group. The group with the highest probability can be picked. Upon termination, the search tree algorithm returns the next K-Tuple which should be observed to begin traversing the best probability path. The marking observation which differs this K-Tuple from the original K-Tuple (effectively) passed into the original invocation of tree_search' is the most likely observation which will lead the user on a path to conversion.

The search tree algorithm can be extended to use a Variable Duration HMM, however a hypothetical inter-click duration generally must be provided to the algorithm representing the time between the last click/event and the next hypothetical click/event. This value can be estimated using the all event stream's average inter-click duration as a base value and then reducing this base value by some multiple of all the event stream's standard deviation, and using this number as the next hypothetically observed inter-click duration. Other methods are possible for computing this estimate under different embodiments.

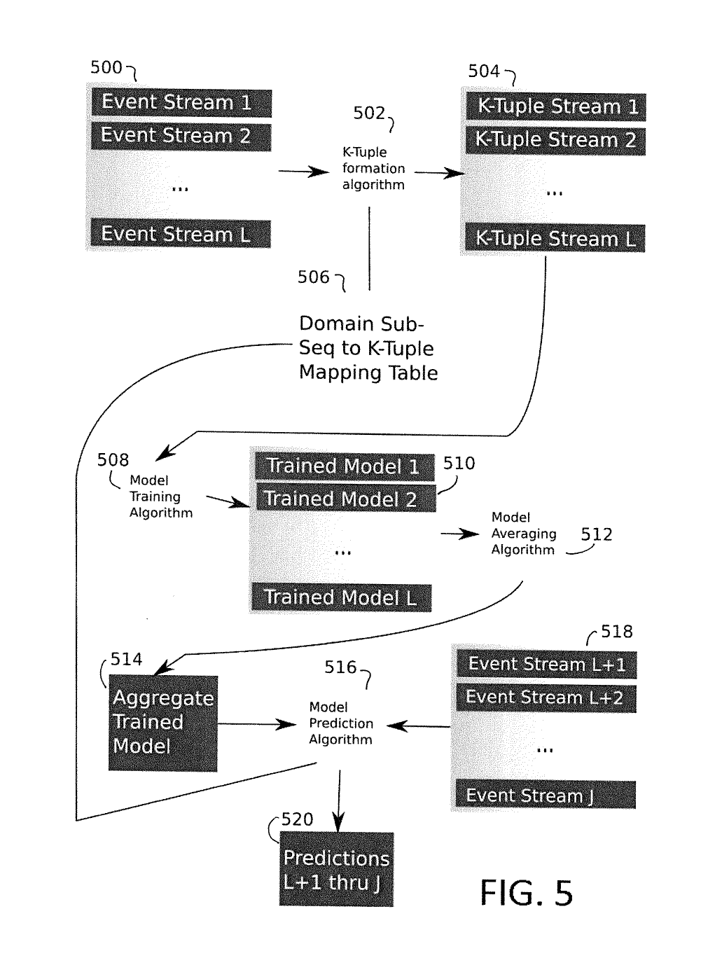

FIG. 5 includes a block diagram showing entities of the entire apparatus and method with respect to the noted embodiment of online advertising, according to embodiments of this invention. FIG. 5 shows the individual blocks of data, data structures, and algorithms, and the connections between them. FIG. 5 is intended to assist in piecing together all the elements of embodiments of the invention. In embodiments of this invention, event streams of data are assumed broken up into two separate groups by a pre-processing algorithm. Those labeled 1 through L are converted event streams, and those labeled L+1 through J are unconverted event streams. Converted event streams in box 500 are converted to K-tuple streams in box 504 by the K-Tuple formation algorithm in circle 502 which uses the Mapping Table 506. A model training algorithm 508 produces L trained models, one per converted event stream. The model averaging algorithm 512 averages or transforms these L models into a single model 514 that can then be used for prediction. The prediction algorithm 516 takes as input the event streams 518, and produces J−L predictions. As previously noted, within the context of online advertising, these predictions can be used individually to influence individual users to convert, or they can be used collectively.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLE(S)

The following example describes a method of this invention within the context of online advertising. In this example, a firm ACME Corporation wishes to advertise its product via a variety of online publishers. In this example, the publishers can be grouped by channel type, which come from the set {A, B, C, D, E, F, G}. The cardinality of this set is 7. A HMM using the method described in this invention can be trained with converted data, with a variety of K, and back tested with the training data or a subset of training data corpus held out from training. Assuming the K which provides the highest level of predictive confidence is 4, which corresponds to a HMM model with alphabet size 98, assuming the unordered model equation in diagram Equation 2. Assuming the marketing funnel has 4 stages, this yields a state transition to state transition matrix of size 4 by 4, and a state transition to observation matrix of size 4 by 98. Presuming there is the highest degree of propensity for the users in the body of converted users to click on an ad shown via a publisher of channel type F, but only after they click on recently shown ads via channel types B and C. The trained model captures this information. Thus, when a particular unconverted user X's most recently logged advertising events are pushed through the model, it is desirable to understand which type of publishing channel will most positively influence this user's path to conversion. The body of unconverted users contains individuals, who may convert (given the correct advertising effect), and in the process, it is assumed that these users will have similar positive responses to the various ordered combinations of advertising channels which have led other users to convert. In this example then, the model and process disclosed herein will then recommend that users who have clicked on an ad from channel type B followed by channel type C (or visa-versa), should then be shown an advertisement via channel type F. Note that in this example the model only captures the prior 3 clicks since K is set to 4, therefore the clicks for B and C must have occurred within the last 3 clicks to enable this model to predict that channel F should be the next channel used in the advertising campaign for this particular user X. Furthermore, by aggregating the predicted channels, it is then possible to arrive at the overall proportion of predicted channels that should be used to influence the body of active unconverted users to become converted users.

The above example describes one ad variation out of many ad variations within the advertising domain, and it should be clear that numerous other embodiments for model features and model training may exist. For example, the model may be designed with channel types, media types, individual publishing entities, or selected combinations of all, as individual observables. The embodiments are not limited to the examples provided in this disclosure. The model may also be designed to model a specific number of states which mirror a specific set of phases leading to conversion, corresponding for example to a product type. The model may also be modified to consider the expected time typically observed when transitioning from state to state. Under certain circumstances models which do this may provide a better estimate of the user's final state, given their advertising event stream data.

Thus, the invention provides a method, and system for implementation, for performing an estimate of an individual's position within a conceptual state space. In particular, the method is useful for targeting online advertisements, and for using known converted sales for predicting the best advertising for converting unconverted clickstreams and future ad campaigns.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of directing electronic advertising to targeted consumers, the method comprising:
tracking digital advertisement interactions for a consumer on one or more electronic devices;
collecting advertising data for the consumer from the tracking;
automatically modeling the advertising data to obtain a predicted advertisement channel for display on the one or more electronic devices; and
displaying a further digital advertisement to the consumer on the one or more electronic devices or a second consumer, via the predicted advertisement channel.

2. The method of claim 1, wherein the tracking digital advertisements interactions comprises tracking and collecting raw data on presentation of advertisements to the consumer, clicks on the advertisements by the consumer, and sales conversions resulting from the clicks on the advertisements.

3. The method of claim 2, further comprising organizing the raw data in a timeline.

4. The method of claim 3, further comprising converting the timeline into an event stream of K-tuples.

5. The method of claim 4, further comprising training a Hidden Markov Model with the event stream of K-tuples that resulted in sales conversions.

6. The method of claim 1, wherein the tracking digital advertisements interactions comprises:
collecting and preparing raw advertising data from the one or more electronic devices, wherein the raw data comprises a plurality of data points and wherein each of the plurality of data points includes a user-specific identifier and a timestamp;
grouping the raw data first by the user-specific identifier and then ordering the raw data by the timestamp;
creating a lookup table with a K-tuple representation in a computer memory, wherein the K-tuple represents K consecutively occurring events;
training a Hidden Markov Model with at least one event stream comprised of K-tuples for advertising that resulted in sales conversions.

7. The method of claim 6, further comprising automatically monitoring and analyzing a predetermined advertising variant among the raw data to identify the at least one event stream for training.

8. The method of claim 6, further comprising automatically monitoring and analyzing clickstream advertising symbols and/or clickstream statistics to identify the at least one event stream for training, wherein the clickstream statistics include inter-click duration, overall clickstream duration, number of touch points, time-stamp derived features, or combinations thereof; and
predicting a most likely entity of interest for a given event stream.

9. The method of claim 6, wherein the lookup table comprises an un-ordered K-tuple with N count advertising symbols, wherein one bit in an integer will be set per advertising symbol set in the list and wherein the integer representing the K-tuple, a most significant bit comprises bit index N-1, a least significant bit comprises bit 0, and a maximum number of bits set in the K-Tuple comprises K, and a minimum number of bits that can be set is 1.

10. The method of claim 9, wherein the advertising symbol comprises one of a channel type of a publishing website used to display the advertisement to the end user, an identifier of the publishing website, or a well-defined discrete attribute of an advertisement's creative image.

11. The method of claim 9, wherein the lookup table comprises an ordered K-tuple with N count advertising symbols, wherein the symbols are arranged in an ordered list, said list indexed from number 0 through N-1, wherein for each possible K-tuple representation, a lookup table located in the computer memory maps a numeric value of the K-tuple to a discrete symbol ranging from 0 to M-1, wherein there are M total combinations of K-tuples.

12. The method of claim 4, further comprising:
processing each event individually from a stream in order of time, starting with an oldest time stamp;
establishing a list L comprising identifiers of advertising entities;
reading an event from the stream, wherein if the stream is empty, then terminate a K-tuple formation;
mapping an identification (ID) of the event to an integer from range 0 to N-1, where there are N discrete advertising entities under consideration;
appending the identification to the list L;
checking a lookup table to determine a symbol S corresponding to the K-tuple represented by items in the list L; and
emitting the symbol S to an output stream of data, wherein the output stream of data is used as observations for training a model.

13. A method of directing electronic advertising to targeted consumers, the method comprising:
tracking digital advertisement interactions for a plurality of consumers on electronic devices;
collecting advertising data for the consumers from the tracking;
automatically grouping the advertising data by a consumer identification;
automatically creating event streams from the advertising data in each group;
automatically modeling the advertising data to obtain a predicted advertisement channel for display to a further consumer; and
displaying a further digital advertisement to the further consumer on an electronic device via the predicted advertisement channel.

14. The method of claim 13, further comprising identifying converted event streams within the each group.

15. The method of claim 14, further comprising training a Hidden Markov Model with the converted event streams.

16. The method of claim 15, further comprising applying the predicted advertising channel to non-converted event streams.

17. The method of claim 13, further comprising determining advertising channel patterns for the converted event streams, wherein the predicted advertisement channel is selected from one or more of the advertising channel patterns for the converted event streams.

18. The method of claim 17, further comprising applying the predicted advertising channel to non-converted event streams to stimulate sales conversion.

19. The method of claim 13, wherein the tracking digital advertisement interactions comprises automatically monitoring and analyzing a predetermined advertising variant among the raw data for the modeling.

20. The method of claim 19, wherein the predetermined advertising variant comprises inter-click durations of a clickstream of the event streams, wherein a faster inter-click duration results in a state transition forwards while a slower than usual inter-click duration results in a state transition backwards, and the method further comprises:
forcing a transition to a final converted state at a last click in each of the event streams; and
predicting a most likely entity of interest for the each of the event streams.
